(19) United States
(12) Patent Application Publication
(10) Pub. No.: US 2002/0076074 A1
(43) Pub. Date: Jun. 20, 2002

(54) Hearing aid

(75) Inventor: Jan Biermans, GZ Best (NL)

Correspondence Address: David G. Beck, McCutchen, Doyle, Brown & Enersen, LLP, 28th Floor, Three Embarcadero Center, San Francisco, CA, 94111, US

(73) Assignee: Beltone Netherlands B.V., Al Eindhoven (NL)

(21) Appl. No.: 09/991,248

(22) Filed: Nov. 16, 2001

(30) Foreign Application Priority Data
Nov. 22, 2000 (NL) 1016684

(51) Int. Cl. H04R 25/00

(52) U.S. Cl. 381/324; 381/322

(57) ABSTRACT

A hearing aid comprising means for setting an adjustment level, means for setting a desired function, a connector and a cover which detachably extends over said connector. The means for setting the adjustment level comprise two contact elements disposed on either side of the connector, wherein the adjustment level can be set higher or lower by means of one contact element or by means of the other, whilst the desired function can be set by operating the two contact elements simultaneously.

The invention relates to a hearing aid comprising means for setting an adjustment level, means for setting a desired function, a connector and a cover which detachably extends over said connector.

In a hearing aid which is known per se, the means for setting an adjustment level, such as the volume, the means for activating or de-activating a desired function and the connector are positioned beside each other, as a result of which said means take up relatively much space. In addition, the user is frequently confused as to which means are intended for setting the adjustment level and which means are intended for activating or de-activating a function.

The object of the invention is to provide a hearing aid wherein the aforesaid components are integrated in the hearing aid in a relatively compact manner.

This objective is accomplished with the hearing aid according to the invention in that the means for setting the adjustment level comprise two contact elements disposed on either side of the connector, wherein the adjustment level can be set higher or lower by means of one contact element or by means of the other, whilst the desired function can be set by operating the two contact elements simultaneously.

In this way the same contact elements are used both as the means for activating or de-activating a desired function and as the means for setting the adjustment level. The required number of components is thus significantly reduced. In addition, there is a clear difference between the operation for setting the adjustment level, wherein only one contact element is operated, and the operation for setting the desired function, wherein the two contact elements are operated simultaneously.

One embodiment of the hearing aid according to the invention is characterized in that the cover extends over the connector and the contact elements that are disposed on either side of the connector, wherein a single contact element can be operated by depressing one end of the cover against spring force, whilst both contact elements can be operated by depressing a part of the cover located near the connector against spring force.

The cover hides the connector as well as the contact elements from view in a simple manner, whilst the cover furthermore functions as a control button both for the means for setting the adjustment level and for the means for setting the desired function.

The invention will now be explained in more detail with reference to the drawing, in which;

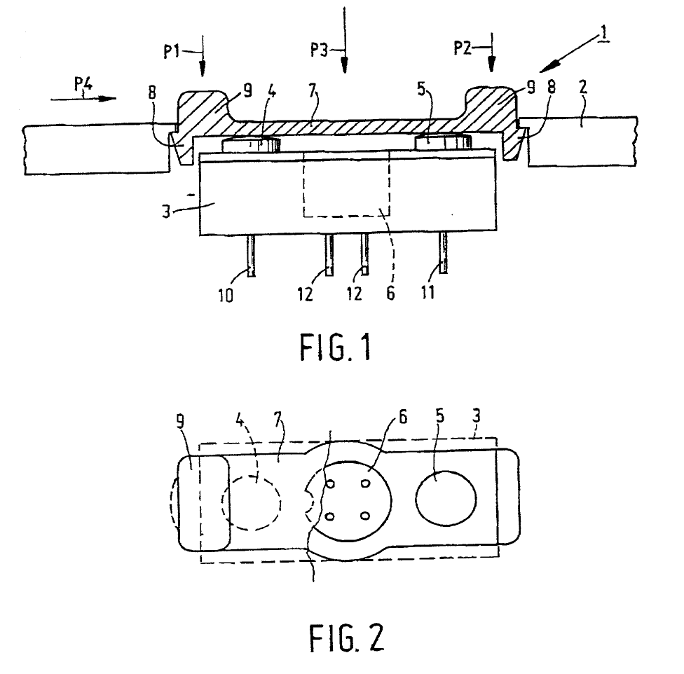

FIG. 1 is a cross-sectional view of part of a hearing aid according to the invention.

FIG. 2 is a top plan view of the part of the hearing aid according to the invention that is shown in FIG. 1,

Like parts are indicated by the same numerals in the figures.

FIG. 1 is a cross-sectional view of part of a hearing aid 1 according to the invention, which comprises a housing 2 and an element 3 disposed within said housing 2. The element 3 is provided with two electrical contacts 4 and 5, which can be operated against spring force, and with a connector present therebetween. A cover 7 extends over the contacts 4, 5 and the connector 6 that is present therebetween, which cover is in detachable engagement with the housing 2 by means of hook-shaped lips 8. The cover 7 is furthermore provided with control buttons 9, which are positioned on either side of the contacts.

Element 3 is provided with connecting pins 10, 11 on a side remote from the cover 7, which connecting pins are connected to contacts 4 and 5, respectively, and with connecting pins 12, which are connected to connector 6.

The operation of the hearing aid 1 according to the invention is as follows. If the user wishes to increase the adjustment level of, for example, the volume of the sound from the hearing aid, he will push the left-hand button 9 in the direction indicated by arrow P1 with one of his fingers, as a result of which the contact 4 is depressed. If the user wishes to reduce the volume, he will push the right-hand button 9 in the direction indicated by arrow P2 with his finger, as a result of which the contact 5 is depressed. If the user wishes to change a function of the hearing aid 1, such as a stored programme, he will push the part of the cover 7 that extends between the buttons 9 in the direction indicated by arrow P3 with one of his fingers, as a result of which the contact 4 and the contact 5 are simultaneously depressed. Obviously, the same result can be obtained by pressing the two control buttons 9 simultaneously.

If the hearing aid 1 is to be connected to an external device, for example for downloading various programmes to the hearing aid, the left-hand pushbutton 9 is moved in the direction indicated by arrow P4, as a result of which the cover 7 is elastically deformed and the hook-shaped element 8 becomes detached from the housing 2. The cover 7 can now be removed, as a result of which the connector 6 becomes accessible for being connected to the external device. As soon as the connector is to be hidden from view again, the cover 7 is connected to the housing 2 in the manner that is shown in FIG. 1. Since the cover 7 is made of a flexible material, operating either one of the contacts 4 or 5 as well as removing the cover 7 from the housing 2 can take place in a relatively simple manner.

It is also possible to change over from volume adjustment to tone adjustment, for example, by pressing the two control buttons 9, after which the tone can be adjusted by pressing one of the contacts 4, 5. Furthermore, it is possible to change over to a three-point control of an AGC circuit, the desired adjustment level of which can be realised by operating one of the control buttons 9. Pressing the two control buttons 9 makes it possible to activate or de-activate various functions, such as programmes that are stored in the hearing aid, but also other types of electronic switching functions, for example switching over from a microphone to a sound coil (for use in rooms fitted with a ring line), and to turn the hearing aid on or off. According to another possibility, a function that is not used very frequently, for example storing the momentaneous settings in the memory as preferred settings, so that said settings will be used from that moment onwards whenever the hearing aid is turned on, can be activated electronically by holding the two control buttons for a relatively long time.

Furthermore it is possible to provide the cover with a relatively long handle, which extends transversely to the cover, instead of using two control buttons, so that some kind of joystick is formed, which joystick can be moved forward and backward for operating one of the contacts 4, 5 and which can be moved in the direction of the connector 6 for operating the two contacts 4. 5 simultaneously.

1. A hearing aid comprising means for setting an adjustment level, means for setting a desired function, a connector and a cover which detachably extends over said connector, characterized in that said means for setting the adjustment level comprise two contact elements disposed on either side of the connector, wherein the adjustment level can be set higher or lower by means of one contact element or by means of the other, whilst the desired function can be set by operating the two contact elements simultaneously.

2. A hearing aid according to claim 1, characterized in that the cover extends over the connector and the contact elements that are disposed on either side of the connector, wherein a single contact element can be operated by depressing one end of the cover against spring force, whilst both contact elements can be operated by depressing a part of the cover located near the connector against spring force.
